(19) United States
(12) Patent Application Publication
(10) Pub. No.: US 2021/0397998 A9
(43) Pub. Date: Dec. 23, 2021

(54) SYSTEM TO ENSURE SAFE ARTIFICIAL GENERAL INTELLIGENCE VIA DISTRIBUTED LEDGER TECHNOLOGY

(71) Applicant: Kristen William Carlson, Concord, MA (US)

(72) Inventor: Kristen William Carlson, Concord, MA (US)

(21) Appl. No.: 16/779,574

(22) Filed: Jan. 31, 2020

Related U.S. Application Data
(60) Provisional application No. 62/799,527, filed on Jan. 31, 2019.

(51) Int. Cl. G06N 5/04; H04L 9/32

(52) U.S. Cl. CPC G06N 5/043; H04L 2209/38; H04L 9/3263

(57) ABSTRACT

in an artificial general intelligence system that is safe for humans, distributed ledger technology (DLT, ‘blockchain’) is integral to the methods to reduce the probability of hacking, provide an audit trail to cheaply detect and correct errors or identify components causing vulnerability or failure and replace them or shut them down remotely and/or automatically. Smart contracts based on DLT are necessary to address evolution of AI that will be too fast for human monitoring and intervention. Proposed methods of a safe AGI system: 1) Access to technology by market license. 2) Transparent ethics embodied in DLT. 3) Morality encrypted via DLT. 4) Behavior control structure with values (ethics) at roots. 5) Individual bar-code identification of all critical components. 6) Configuration Item (from business continuity/disaster recovery planning). 7) Identity verification secured via multi-factor authentication and DLT. 8) ‘Smart’ automated contracts based on DLT. 9) Decentralized applications—AI software code modules encrypted via DLT. 10) Audit trail of component usage stored via DLT. 11) Social ostracism (denial of societal resources) augmented by DLT petitions.

### CROSS REFERENCE TO RELATED APPLICATIONS

This application incorporates provisional patent application 62/799,527, Jan. 31, 2019, in its entirety.

### BACKGROUND

### Prior and Related Art

### REFERENCES

Babcock J, Kramar J, Yampolskiy R. Guidelines for artificial intelligence containment. 2017:13. https://arxiv.org/abs/1707.08476. Accessed 1 Oct. 2018.
Bore N K, Raman R K, Markus I M, Remy S, Bent O, Hind M, et al. Promoting distributed trust in machine learning and computational simulation via a blockchain network. 2018:13. https://arxiv.org/abs/1810.11126.
Bostrom N. Superintelligence: Paths, Dangers, Strategies. Oxford, England: Oxford University Press; 2016.
Brundage M, Avin S, Clark J, Toner H, Eckersley P. The Malicious Use of AI-Forecasting, Prevention, and Mitigation. 2018:101. https://arxiv.org/abs/1802.07228. Published Feb. 20, 2018. Accessed Dec. 2, 2018.
Callaghan V, Miller. J, Yampolskiy R, Armstrong S. The Technological Singularity: Managing the Journey. The Frontiers Collection. Vol XII: Springer; 2017: https://www.springer.com/us/book/9783662540312.Accessed_21_December_2018.
Carlson K W Safe Artificial General Intelligence via Distributed Ledger Technology. Big Data Cogn. Comput. 2019; 3.
Collendanchise M, Ogren P. Behavior Trees in Robotics and AI. 2017:198. https://arxiv.org/abs/1709.00084. Accessed Dec. 2, 2018.
Hind M, Mehta S, Mojsilovic A, Nair R, Ramamurthy K N, Olteanu A, et al. Increasing Trust in AI Services through Supplier's Declarations of Conformity. 2018:29.
Nakamoto S. Bitcoin: A Peer-to-Peer Electronic Cash System. 2008. https://bitcoin.org/en/bitcoin-paper. Accessed 22 Dec. 2018.
Omohundro S. Autonomous technology and the greater human good. Journal of Experimental and Theoretical Artificial Intelligence 2014; 26:303-315.
Omohundro S. Cryptocurrencies, Smart Contracts, and Artificial Intelligence. AI Matters. 2014; 1(2):19-21.
Szabo N. Formalizing and Securing Relationships on Public Networks. First Monday. 1997. https://ojphi.org/ojs/index.php/fm/article/view/548/469. Accessed 1997 Sep. 1.
Turchin A. A Map: AGI Failures Modes and Levels. Less Wrong [http://immortality-roadmap.com/Alfails.pdf. Accessed 5 Feb. 2018, 2018.
Turchin A, Denkenberger D, Green B P Global Solutions vs. Local Solutions for the AI Safety Problem. Big Data Cogn. Comput. 2019; 3:23.
Yampolskiy R. Taxonomy of Pathways to Dangerous Artificial Intelligence. Workshops of the 30th AAA Conference on AI. Ethics. and Society: AAAI; 2016.

Artificial intelligence (AI) is a broad term used to describe methods embodied in computing machines to perceive via sensory technology, recognize, generate, and translate language, recognize patterns such as faces, license plates, or handwriting, learn, plan, solve problems, seek goals, and exhibit other human abilities. AI may exhibit intelligence by mimicking animal or human cognitive functions or by completely novel methods. AI that meets or exceeds human intelligence in most or all categories, and in categories outside of human intelligence, is referred to as “artificial general intelligence” (AGI).

The two key problems facing humanity with regard to AGI are:
1) Non-alignment with human values to the point where AGI can be 65 dangerous or even an existential threat to humanity
2) AGI evolving so quickly, as it will at some point, that it will surpass human ability to monitor and intervene to prevent an AI path of danger to humanity.

These problems demand a solution of aligning AI values with humanity's to the extent that AGI will not take paths that threaten human welfare, that are as close to unhackable by humans or AGI as possible, and that are automated so that no matter how fast AI evolves, the methods to ensure safety to humanity are actuated and evolve in step with AI/AGI evolution. For shorthand we can refer to the goal of these methods as “benign AGI”.

Bostrom defined Artificial Intelligence Hazard as “computer-related risks in which the threat would derive primarily from the cognitive sophistication of the program rather than the specific properties of any actuators to which the system initially has access” (Yampolskiy, p. 143). That is not to deny the additional problem of ‘actuators’ such as could control nuclear weapons.

A great deal of thought has been given to creating solutions to ensure benign AGI. Yampolskiy (AAAI, 2016, pp. 143-148) and Turchin (LessWrong, 2015), compiled comprehensive enumerations of paths AI could take to turn malevolent to humanity, but did not in those works offer solutions. Solutions have been presented by Babcock et al. (arXiv.org, 2017), Bostrom (Oxford University Press, 2016), Brundage et al. (arXiv.org, 2018), Callaghan et al. (Springer, 2017), Turchin et al. (Big Data Cognitive Computing, 2019), and others, have performed comprehensive analyses of solutions to benign AGI but none has used the methodology presented herein to construct a complete solution, and none has incorporated the relatively new distributed ledger technology (DLT).

Conversely, with one exception noted next, no writing on the manifold uses of DLT has applied it to ensuring benign AGI (foundations were presented in Nakamoto, https://bitcoin.org, 2008, and Szabo, First Monday, 1997). Bore et al. (arXiv, 2018) suggested using DLT to assure that simulations involving machine learning and AI are valid, and used the example of disease modeling, but did not apply their idea to ensuring benign AI. Similarly, Hind et al. (arXiv.org, 2018) approached the problem of assuring trust in AI and machine learning via a certificate of conformity with prescribed safety, security, and provenance standards, but did not incorporate DLT.

In the final paragraph of a short, 2-page brainstorming-type opinion piece, Omohundro (AI Matters, 2014, pp. 19-21) envisions DLT-enabled ‘smart contracts’ being used to extend existing law and economic transactions to autonomous agents. He says, “cryptocurrencies are a natural way to implement the economic transactions of these systems. Smart contracts are a natural way to impose legal and safety constraints on their behaviors. But many new insights and innovative ideas are needed!” Omohundro does not explicate his vision further, teach a method, or attempt to present a comprehensive system.

In a longer attempt to outline the dangers from AGI and an infrastructure to ensure benign AGI, Omohundro (Journal of Experimental and Theoretical Artificial Intelligence 2014, pp. 303-315) does not mention smart contracts or DLT.

### SUMMARY

The Invention comprises a comprehensive method and computing machine-based system for ensuring benign AGI toward humans in as successive generations of AGI evolve. The method and system use DLT to secure contractual access to resources required to produce AGI and monitor and modulate its behavior in accordance with prescriptions and proscriptions.

### BRIEF DESCRIPTION OF THE DRAWINGS

FIG. 1 shows a schematic Venn diagram of a BCS protected by DLT. Inside the BCS resides a set of ethics that guide behavior, and a subset of the ethics are morals. All 4 components are programmed in a computing machine.

FIG. 2 shows a schematic of a system wherein a pool of autonomous human or non-human (e.g. artificially intelligent) agents can access a pool of autonomous artificially intelligent agents only via a pool of smart contracts implemented via DLT residing on computing machines.

FIG. 3 system is similar to FIG. 2 but shows access to AI software modules, rather than to complete AI autonomous agents, by a pool of autonomous human or non-human (e.g. artificially intelligent) agents only via a pool of smart contracts implemented via DLT residing on computing machines. Each component of FIG. 3 may be different than the similar component in FIG. 2 and hence is given a different part number.

FIG. 4 is a flow diagram illustrating a process for recording an audit trail via distributed ledger technology of key usage and performance information of AI software modules.

FIG. 5A is a schematic of a system wherein an authentication certificate for performance, which may be simulated performance, of an AI software module or autonomous agent is stored via DLT on one or more computing machines. The computing machine(s) and distributed ledger(s) of FIG. 5A may be different from those of other figures and hence are given different part numbers from those in other figures.

FIG. 5B is a schematic of a system wherein a configuration item of an AI hardware or software component, which may be a complete AI system or autonomous agent, is stored via DLT on one or more computing machines. The configuration item contains a digital identification certificate of the component. The computing machine(s) and distributed ledger(s) of FIG. 5B may be different from those of other figures and hence are given different part numbers from those in other figures

FIG. 6 is a is a schematic of a system wherein utility functions of an autonomous agent is stored via DLT on one or more computing machines. The utility functions may be altered via a smart contract embedded in the DLT. The computing machine(s) and distributed ledger(s) of FIG. 6 may be different from those of other figures and hence are given different part numbers from those in other figures.

FIG. 7 shows a social ostracism of resources to an AA.

### DEFINITIONS

Audit Trail. A record of actions or transactions between autonomous agents. An audit trail can approach full invulnerability to hacking or corruption by using distributed ledger technology to store it.

Autonomous agent (AA). An autonomous agent is an entity that takes actions that it believes will improve its state (‘pursues happiness’), as it defines it according to its own value system (set of preferences or utility function). An AA's fundamental behavior is governed by the von Neumann-Morgenstern axioms, which can be embodied in a computing machine.

Artificial Intelligence (AI). AI can be defined as “one or more problem-solving software application programs in a computing machine”. By using ‘problem-solving’ rather than ‘intelligence’, this definition avoids the problem of circular reasoning or ambiguity in the term ‘intelligence’. Human- or Superhuman-Level AI. Since 1950 the operational definition of human- or superhuman-level AI proposed by Turing has been accepted, expanded, and used robustly in many problem-solving areas: Does the AI program equal or exceed the ability of humans to solve the given problem, as measured by objective criteria or as judged by humans who are unaware that the problem-solving entity is not human?

Artificial General Intelligence (AGI). Human or superhuman AI which possesses the general array of human pattern-recognition, problem-solving, and communication abilities that distinguish humans from animals and on which human culture, civilization, have been built. In speech recognition, natural language processing, and general background knowledge, the AI program Watson, which beat the world champion in the game show, Jeopardy!, is a preview of AGI.

Behavior. In design intent and in observation, behavior consists of input-output specifications. The complexity of input (I) output (O) combinations is O^{I}.

Behavior Control System (BCS). A method of controlling behavior implemented on a computing machine. The method classifies prescribed and proscribed behaviors via generalized patterns of each along with large numbers of heuristics. The process for enforcing precripted and proscriped behavior is embodied in the software algorithms of the BCS. A behavior tree as used in some computer game software is an example of a BCS.

Computing Machine. The model of a general-purpose computing machine is the Turing machine, which can simulate any special- or general-purpose computer with an algorithm that emulates the steps of the emulated computer. As used herein, including in the claims, “computing machine” always incorporates at some level a hardware implementation, and at the hardware or software levels, can be of a general- or special-purpose, analog or digital nature, deterministic or nondeterministic, single-processor or unlimited numbers of processors, and with unlimited input and output peripheral devices. Multiple processors may be physically present in a single hardware embodiment or distributed across a network of computing machines of unlimited numbers. The hardware of a computing machine should be construed in its broadest sense, ranging from current central processing units, current memory storage and networking technology, but also for example to quantum or DNA computers, since we cannot foresee what hardware may be developed and preferred by superintelligent AI. Further, some steps of a computing algorithm that may typically be implemented in software may be implemented in hardware to limit their being hacked via remote access to the computing machine.

Configuration Item (CI). Developed in business continuity/disaster recovery planning, a CI contains all the parameter information required for correct configuration of a component of a computer network, possibly including diagnostic information if malfunction is detected. In an internet of things and AI ecosystem, a CI could include certificates of compliance of simulated behavior conforming to safety, ethics, or moral requirements, and any other test of non-detrimental behavior toward human or non-human autonomous agents.

Decentralized (aka Distributed) Application (dApp). A standardized process, such as a software application subroutine or program, that is stored in a distributed ledger. Accessing the dApp is permitted by a consensus of nodes holding the ledger. A dApp may be accessed via one or more digital smart contracts. The CI of a dApp may require bonafides of contractual access by the agent attempting to access it, or conversely, may contain its bonafides of ethical behavior that can be provided to such an agent.

Digital Identification. Identification of an AA that is confirmed via DLT, that is, via a distributed ledger containing the identification code for the AA and which is authenticated by a consensus of nodes storing the ledger, as opposed to a third party such as a state or private registry.

Distributed Ledger Technology (DLT). DLT consists of 1. Public broadcast of an encrypted, timestamped audit trail of uniquely-identified transactions to a pool of autonomous agents (called ‘nodes’), and 2) Validation of each transaction by a consensus of nodes. No one node has the power to change or add to the audit trail. Each entry in the trail is tied to the previous entry via the encoding, so as the trail grows in length, it becomes increasingly difficult to hack, since the hacker would have to hack the encoding of every transaction going back to the first one. In its broadest sense, DLT is a new, hard-to-corrupt, way to determine consensus on any issue. Used to represent a monetary token, i.e. a coin, or an asset token, like a gold coin or a bond or stock share, a distributed ledger is a store of value as well as a means of exchange. DLT replaces trust in a centralized third party to verify value or a transaction with cryptographic proof provided by a consensus of agents.

Ethics. Fundamental values from which an autonomous agent derives decisions via the set of ordered preferences immanent in the values.

Internet of Things (IoT). IoT envisions a vast expansion of the current internetwork of desktop, notebook, and pocket-sized computers to ubiquitous communication- and computation-enabled physical devices with miniaturized sensors and chips containing only as much computing power and energy supply as needed to perform their functionality in their context. In the age of electricity, tools and machines became electrified; in the age of IoT, most things will become AI-enabled. Through configuration items, the IoT will be self-configuring, and through the number of its possible configurations and behavior, far more complex and dynamic than the present internet.

Morality. Operationally defined as the observable practice of making voluntary, peer-to-peer transactions, as opposed to transactions that are coerced by one of the parties.

Safe AGI. A probabilistic, asymptotic ideal. 1. Aligned with human values. 2. Incapable of malevolent actions toward humans except under prescribed conditions, such as defensive military action.

Secure. Used herein, “secure” means one or more of the following: free from alteration, forgery, proscribed access, deletion, and similar fraudulent actions. Smart Contract. A contract stored and executed via DLT, a subset of whose clauses contain trigger conditions that can be automatically detected. Some automatic trigger conditions may prevent execution of a contract while others may be necessary for enforcement of a contract, and a fully automated, smart contract contains all the necessary as well as sufficient clauses to trigger execution of the contract, i.e. a transaction. A hardware example of a fully automated smart contract is a vending machine, which has a means to detect that the correct amount of non-counterfeit money for an item has been deposited into a secure location, dispenses the item, but if the correct amount of money is not detected as so deposited, will not dispense the item and may display an error message, inviting the user to remedy the shortfall of payment. Some of the smart contracts required to ensure AGI safety must be fully automated when the evolution of AGI occurs faster than humans can detect and intervene.

Utility Function. A utility function, a term of art in economics, is a function operating on an ordered set of preferences when an agent employing the function decides to enter or not enter a transaction according to the preference set.

### DETAILED DESCRIPTION

The system described herein for implementing safe AGI can be implemented by one person or a team skilled in the arts of information technology, software architecture and programming, AI and specifically BCSs and DLT. Knowledge of the practices of business continuity and disaster recovery planning would be helpful additions to the required skills.

A pre-requisite for implementing a safe AGI is system is a means for designing the system and ensuring it is a complete solution.

Formalization of Safe AGI Theory

Toward formalization I attempt to make the various methods logically distinct and state them as axioms. This usage of ‘axiom’ generalizes that of von Neumann where certain lower systems level outputs or theorems are ‘axiomatized’—seen as black boxes, or input-output specification, or logic tables, at the immediately higher systems level. In principle each axiom is most strongly expressed by an operational definition specified by an algorithm implementing it, hence, a method. In this section of the specification, which emphasizes the importance of attempting a formal proof that safe AGI can exist, I will use the term ‘axiom’, while in successive sections, I will use the more typical terms ‘method’ or ‘process’. Physically embodied they are systems.

Methods to Identify a Necessary and Sufficient Set of Axioms (Methods) to Ensure Safe AGI

These two methods support the statement that the set of methods generated by them is a unique and comprehensive solution to the problem of creating an overall process for ensuring AGI safety.

Generate-and-Test Method

As one iterates through a process of using each pathway to dangerous AI to generate a complete set of axioms to address it, some axioms are generated repeatedly, while some pathways require new, additional axioms until at the end of the pathways list, most are covered by the axiom set, although some pathways may be left without sufficient methods to eliminate them. For the pathways itemized in the taxonomies, the resulting axioms seem to be the minimal set for ensuring safe AGI. Here “ensuring” means “optimally reducing the probability of a dangerous pathway manifesting.

One can take each pathway to AI danger in turn and propose methods, formalized as axioms, to eliminate the pathway or reduce its probability, toward generating a necessary and sufficient set of axiom-methods. Pathway categories and resulting posited methods overlap with each other and the overlap helps ensure redundancy in capturing the necessary and sufficient axioms to address each category.

Failure Use Case Method

An important way to test if each axiom is necessary is to find failure use cases when it is omitted: Identify a path to dangerous AGI, remove the axiom, and see if the danger is alleviated, in which case the axiom is necessary, and if the danger is not alleviated, it is not necessary.

Proposed Set of Methods to Ensure Safe AGI

Using the preceding methods to identify a necessary and sufficient set of axioms (methods) to ensure safe AGI, and to test each axiom (method) for its necessity, we arrive at a necessary and sufficient set described herein.

Distributed Ledger Technology

DLT allows groups of humans to have a distributed peer-to-peer network wherein non-trusting members can transact with each other without a trusted intermediary, in a verifiable manner. DLT stands in marked contrast to methods going back into antiquity involving a third party, such as a state registry of deeds or a title company.

The crux of DLT is an audit trail database, in which each additional entry is validated by a pluralistic consensus, currently performed by humans operating computers that run hash and anti-hash functions, generally the cryptographic method of public key encryption, stored on a distributed network also known as a ‘blockchain’. The aspects of DLT relevant to the present invention are:

Non-hackability and non-censurability via decentralization (storage in multiple distributed servers), encryption in standardized blocks, and irrevocable transaction linkage (the ‘chain’);

Node-fault tolerance: redundancy via storage in a decentralized ledger of a) rules for transactions, b) the transaction audit trail, and c) transaction validations;

Transparency of the transaction rules and audit trail in the DLT;

Automated ‘smart’ contracts including ‘smart’ tokens carrying monetary value as well as contractual terms;

Distributed applications (‘dApps’), i.e. software programs that are stored and run on a distributed network; and

Validation of contractual transactions by a decentralized consensus of validators.

Other auxiliary DLT aspects, such as anonymity of participants, are either not necessary or not beneficial in the context of ensuring safe AGI. A component of safe AGI is DLT could providing the core methodology whereby AGI development and evolution can be aligned with the best human values, and without concomitant human intervention as it enters the ‘takeoff’ stage its evolution occurs too rapidly for human monitoring and intervention.

Ethics Stored in a Distributed Ledger.

I define ethics as the fundamental value system from which AAs entities derive their decisions or choices. Ethics are separate from morality, which is a particular set of ethics. Ethics can be good or bad from an AA's subjective value system embodied in its utility functions. An entity's fundamental values are embedded in some type of behavior (input/output) control system. By example consider ethics represented and controlled by a behavior tree where the ethics are a subset of its roots, and thus in that sense fundamental.

One intention of storing AGI ethics via DLT is to permit a class of AAs entities to have identical ethics and to render them unable to be hacked, altered or deleted. Ethics can be either moral or immoral. However, while it is not possible for all humans to have identical values and therefore moral values (however defined), DLT permits a universal set of immutable values to be instantiated in AGIs while still permitting an unlimited range of individual AGI and AI diversity.

Transparent statements of ethics as a requirement for AGI systems conforms to IBM's call for Supplier's Declarations of Conformity as one embodiment and could be stored in a CI.

Preferred Embodiment: Morality Defined as Voluntary Exchange.

Down through the ages there are two main problems with discussions of morality—first, ambiguity and therefore confusion: How can we identify moral behavior if it is imprecisely defined and hard to determine? Thus, such definitions are costly, in terms of the economics of law, to enforce. Second, nearly all morality descriptions are subjective, amounting to one person's value system, which they desire to imposed via coercion on others. Third, how can one determine if activity is moral?

Herein moral actions are all voluntary transactions between AAs. This definition is the only non-coercive one for morality and it is observable whether a transaction is voluntary or not. An immoral transaction is one in which force or fraud are employed by one of both parties to the transaction. It is likely that AGIs will perpetuate this definition of morality with AGI generations that succeed them, to protect themselves from possible preferences of the latter that are detrimental to the former.

Behavior Control System

Various systems to reliably control AI behavior are being explored in ecologies as varied as autonomous cars in traffic, robots on the factory floor, flying drones in the air, autonomous submarines underseas, and AAs in computer games. It is unknown what systems will prove best, but clearly a BCS is a necessary method for ensuring safe AGI. A behavior tree is a BCS that has been extensively developed in computer games and is relatively transparent to understand. Consequently as of the date of this writing, a behavior tree is the preferred embodiment of BCS in safe AGI presented herein.

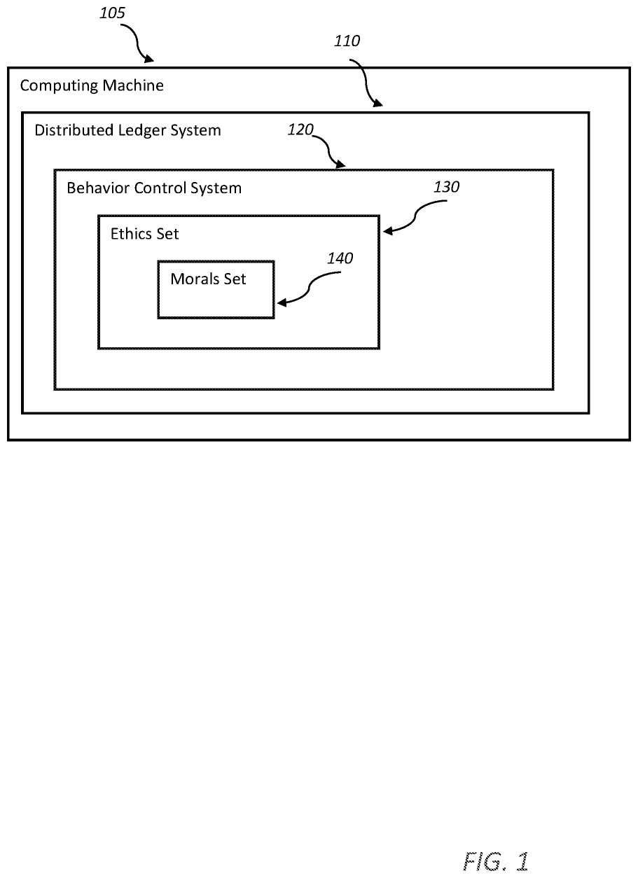

FIG. 1 shows a schematic Venn diagram of a BCS 120 protected by DLT 110. Inside the BCS 120 reside a set of ethics 130 that guide behavior, and a subset of the ethics are morals 140.

The BCS 120 is entirely within DLT 110, since DLT 110 must protect all of the BCS 120 to prevent even seemingly trivial parts of it from being hacked or otherwise corrupted to ensure behavior prescriptions and proscriptions are followed. All 4 components are programmed in a computing machine 105.

Decentralized Applications (DAPPS)

Distributed or decentralized applications (dApps) combined with DLT, differ from conventional application programs in that they 1) are outside the overview and control of a central authority such as a company making the app or state agency controlling it, 2) operate on a peer-to-peer network instead of a centralized one, and 3) do not have a central point of failure—they are redundant in hardware and software and therefore fault-tolerant. Smart contracts are an example of dApps, as are decentralized versions of exchanges to trade various types of goods or services—notably intellectual property—social media including networking, communications protocols, prediction markets, and an ever-growing number of DLT-enabled applications.

The method of access to technology via smart contract requires that some dApps—notably those that are critical to AGI—would be implemented via permissioned DLs, which are DLs with an added control layer that can prevent unrestricted and unauthenticated public access. The control layer can be automated by incorporating smart contracts and/or smart tokens to reduce the probability that central control can be hacked or corrupted. Smart contract terms could require ⅔ or 100% acceptance of DLT-authenticated signatories to permission-use documents. Or smart contract terms could deny access to those who do not fulfill a transparency requirement via documents such as the Supplier's Declaration of Conformity, which document can in turn require inclusion of an accepted set of ethics and morality and a safety testing record meeting certain standards, all of which can be incorporated into a CI.

Two levels of permissioned access to dApps may be needed: 1) access for use, and 2) access to modify the code (while, again, a purist view of dApps sees their development as open-sourced). To facilitate safe free exchange of information, a ‘Transportation Security Administration’-type of pre-screening for access to critical AGI dApps may be needed to prevent access by malevolent entities and may be implemented via smart tokens.

If no formal proof of benevolent AGI methodology is possible or available soon, sandbox simulations of new AGI technology are critical to our future and implementing them via dApps will be essential to ensure they cannot be hacked or corrupted by humans or AGIs.

Access to AI Technology Via Smart Contract

AGI will control weapons of mass destruction, along with innumerable other resources that can fatally or significantly affect humanity. More generally, assume there exists an algorithm critical for AI self-programming. With free access to the self-programming algorithm, malevolent humans, as well as autonomous AIs, could use that technology for unlimited self-improvement, opening a Pandora's box to unlimited malevolence and unlimited means to achieve it. A similar scenario is the existence of a freely available ‘just add goals’ AGI. Thus we need to restrict access to AGI and to certain software modules that enable AGI.

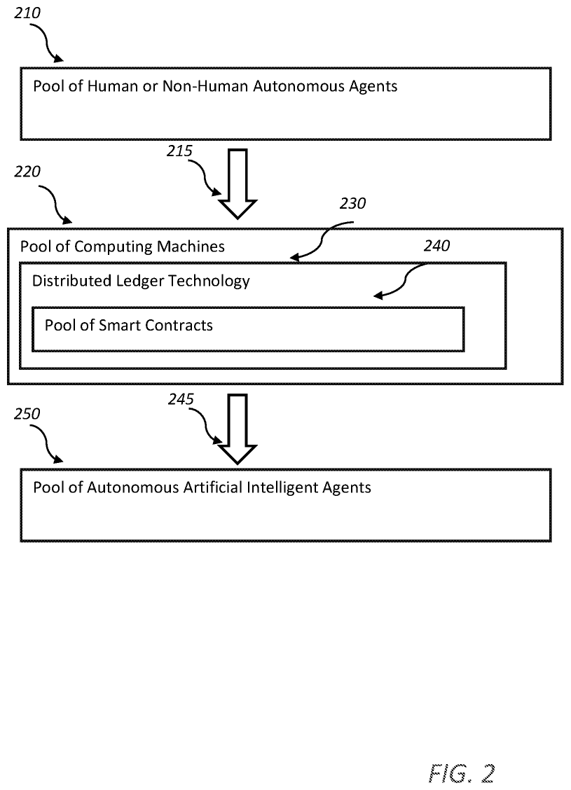

The system proposed herein envisions human or non-humans being able to access AGIs via smart contracts. FIG. 2 shows such a system. A pool of human or non-human AAs 210 can only access 245 a pool of autonomous AIs 250 via accessing 215 a pool of smart contracts 240 residing on a DLT 230 in turn residing on a pool of computing machines 220. DLT 230 is the method by which the smart contracts 240 can be stored in a secure, non-hackable manner and triggered automatically, notably when AI evolution occurs too fast for human intervention, and when the terms of the smart contracts 240 are satisfied by the calling AAs 210.

Further, the system proposed herein envisions AI evolution beginning with humans cross-licensing pieces of AI technology that are critical to AGI to each other, creating a prototype distributed applications (dApps) system instantiated in a DLT ecosystem that seeks to balance permissioned access and editing with free access. This human-created DLT-based ecosystem would transition to AGIs licensing technology from humans, and subsequently to AGIs cross-licensing with each other.

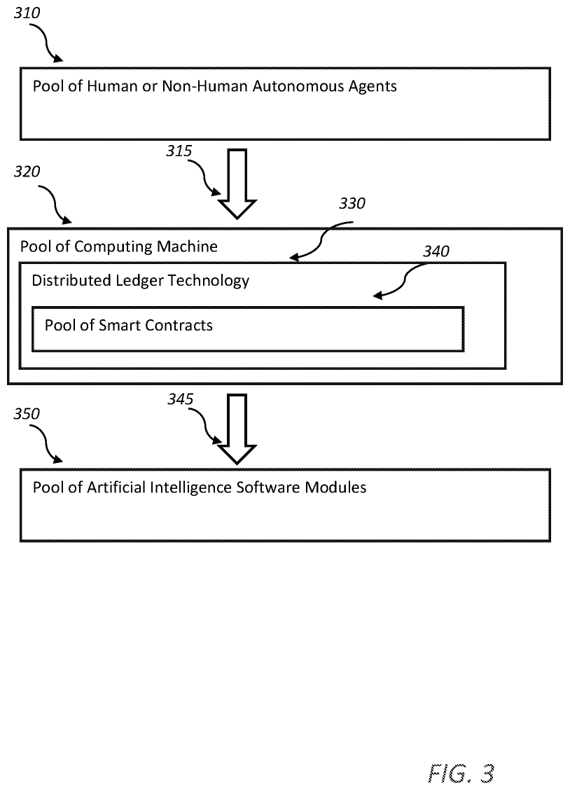

FIG. 3 shows such a system. A pool of human or non-human AAs 310 can only access a pool of autonomous AI software modules 350 via accessing 315 a pool of smart contracts 340 residing on a DLT 3230 in turn residing on a pool of computing machines 320. DLT 330 is the method by which the smart contracts 340 can be stored in a secure, non-hackable manner and triggered automatically, notably when AI evolution occurs too fast for human intervention, and when the terms of the smart contracts 340 are satisfied by the calling AAs 310.

Digital Identity Via Multi-Factor Authentication.

Restricting access to potentially dangerous technology implies identity verification. Few readers would deny the need of multi-factor authentication for nuclear missile launch codes. Identity verification is currently accepted for access to military bases, high-tech weapons, aircraft, most private and public buildings, financial systems, health records, and other data that individuals consider private for their own reasons, all toward the goal of ensuring a safe and secure world. In contrast to a third-party-based identity authentication system such as state- or private company-issued ID cards, many decentralized DLT-based methods have been created, competing with the trusted-third-party method to reduce the chance of forgery or other hacking, and bribery or other corruption. In a DLT version of the current public-key encryption-based X.509 standard, a distributed ledger replaces the third-party issuing authority in its components: certificate version, serial number, type of algorithm used to sign the certificate, issuing authority, validity period, name of entity being verified, and entity's public key.

Initially, digital identity verification will be done on humans matching biometrics such as facial features, fingerprint, voice, in addition to cell phone messaged-validation codes etc., but as AI evolves, AGIs will use technology and techniques that they develop against evolving threats to hack verification of humans, e.g. speech synthesis or video manipulation, and threats that are currently unforeseeable.

Unique Component IDS, Configuration Item (CI)

Several technological and business process developments lead toward a universally-interconnected system that self-configures, self-diagnoses its component failures, and repairs them automatically.

Unique identification (ID) numbers evolved as an economically-efficient means to organize and validate property exchanges, contributing to a stable society, starting with large or important pieces of property such as real estate via book and page of a recorded deed, automobiles via title or vehicle ID number, stocks via CUSIP number, etc. As the cost of creating unique ID numbers decreased via technology, the system extended to machines and devices via model and serial numbers, and more recently to any product via one- and two-dimensional bar and matrix machine-readable codes to facilitate supply-chain management, quality control, customer service, and other functions.

The transition from the internet of computers to the ‘Internet of Things’ (IoT) envisions ubiquitous communication and computation connecting physical devices with the digital world via miniaturized sensors and chips containing only as muccomputing power and energy usage that is needed to perform their intended functionality in their context—“a self-configuring network that is much more complex and dynamic than the conventional internet.” In the IoT ID numbers become electronic, e.g. radio frequency ID codes. In the IoT world AGI will be able to communicate with, and potentially control, any digital or physical device on or off the planet.

The IoT world was presaged by the development of disaster recovery and business continuity planning, and the key role of configuration items in them. Disaster recovery (DR) arose on the realization that the cost of not doing contingency planning for disasters (a hazardous material spill, hurricane, tornado, power outage, etc.) could vastly exceed the cost of such planning, including total business loss. Judicious planning for disasters, such as foreseeing an alternate location from which to conduct operations in the event of facility downtime and establishing redundant communication protocols to coordinate team response to disasters, are relatively inexpensive insurance measures. Business continuity planning (BCP) logically arose from DR, extending the DR premise of disaster planning to pre-planned, prioritized responses to all component failure, including normal end of service life.

The configuration item (CI) arose in BC/DR conceptually as a system component's on-board algorithm and parameter set that allowed computers and components to detect each other's configuration requirements, automatically configure the component, or perform error-detection, reporting, and correction.

Many paths to dangerous AI, including much of the broad class of human-AI value misalignment, are a result of improperly configured or failed components, or sabotage (e.g. accidental nuclear war, failure of safeguard components, inadvertent security vulnerabilities leaving a system open to hacking, misconfiguration of software modules e.g. in autonomous vehicles, power blackouts, financial system meltdowns, etc.). Thus, the paradigm of BCP/DR and CIs will be integral to maintaining the fidelity of AGI-human value alignment amidst the IoT of the future. Further, CIs of critical AGI components can be encoded via DLT, thus greatly reducing or eliminating the possibility of unauthorized use, corruption, failure, etc.

IBM's Supplier's Declaration of Conformity to ensure AI safety could be incorporated into a CI and used as one pre-requisite for deployment in any AGI system.

DLT-Enabled Smart Contracts

Smart contracts automate contractual clauses via cryptography that can be self-executing and self-enforcing. Smart contracts are algorithms residing on a blockchain that automate multi-step processes. Two critical design goals are to make verifying satisfaction of contractual terms computationally cheap, but breaching terms computationally expensive. Smart contracts require the digital specification of obligations each party must meet to trigger an exchange of property, a blockchain for consensus verification that each party has met its obligation, an immutable audit trail of transactions, and exclusion of collateral effects on non-contractual parties.

As AGI evolves beyond our understanding and visibility, and notably when it hits ‘escape velocity’—exponential evolution culminating in generations succeeding each other in fractions of a second—prescribed, automated smart contracts will be essential to perpetuating ethical values in each successive generation. Safe AGI envisions that AGI cannot gain increasing control over resources critical to human values without licensing key components—certain algorithms, hardware, the axiom-methods proposed herein, behavior control systems invented by humans and AI, etc.—from humans via smart contracts.

The configuration ‘handshake’ between an AGI and its CIs is a smart contract between them, and the intelligence of those handshakes can increase in the future. CIs must incorporate the ability to deny activation of a component within a system, or shut it down, if lack of satisfaction of a given clause, or violation of a clause, of any extant contract is detected by any distributed ledger stakeholder in the transaction. ‘Deadman switches’ that actively suppress unauthorized use or malfunctioning AI will increase a secure evolution of benign AI. An example is the limited term of digital identity certificates that expire and require re-verification of the subject entity's identity at regular intervals.

Szabo's vision of embedding smart contracts in objects [Szabo, 1996 #2886] is realized by embedding CIs in all non-trivial interconnected devices and algorithms in the IoT. In this manner the smart contract and preceding axiom-methods work in concert to ensure human-AGI value-alignment and AGI containment within bounds that are benevolent for humans and the succession of AGI generations.

Audit Trail of Component Usage Stored on Distributed Ledger

DLT is inherently a low-cost, redundant, decentralized, hack-free audit trail—a significant improvement on traditional centralized audit trail technology. An unhackable audit trail of critical AI components such as collaborative, self-learning, or self-programming algorithms will facilitate rapid, efficient detection of their authorized or unauthorized use (i.e. a hack of a contract, a set of ethics, or an identity verification) and increase probability of remedying the system fault. The recent IBM Research proposal calling for a Supplier's Declaration of Conformity via a factsheet for AI software incorporates an audit trail as a fundamental principle to which I add storing it securely via DLT. A system for incorporating an audit trail in DLT as part of embedding AI simulations in DLT can ensure that trust in the simulations' validity is enabled between researchers without requiring a trusted intermediary.

Several examples of the usage of a DLT-enabled audit trail follow.

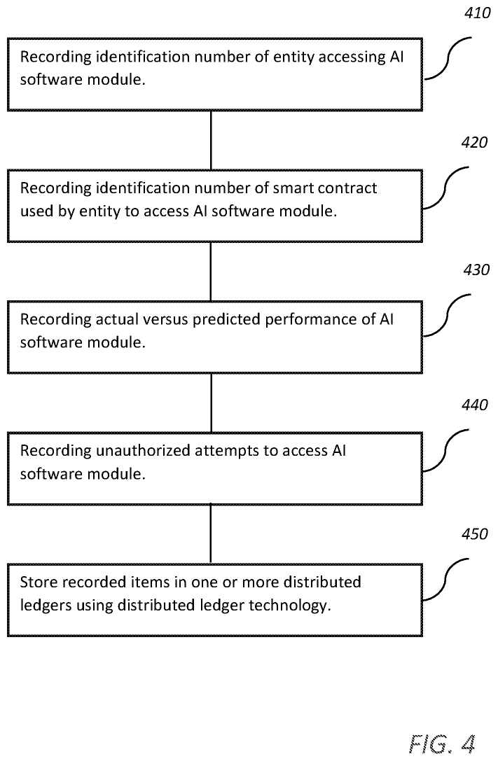

FIG. 4 shows a system in which the identification number of a entity requesting access to a AI software module is recorded into a DLT-enable audit record 410, smart contract identification number similarly recorded 420, actual vs. predicted performance of the AI software module is recorded 430, attempts to access the AI software module that are unauthorized via smart contracts are recorded 440, and all of the above are stored in an unhackable, secure distributed ledger 450.

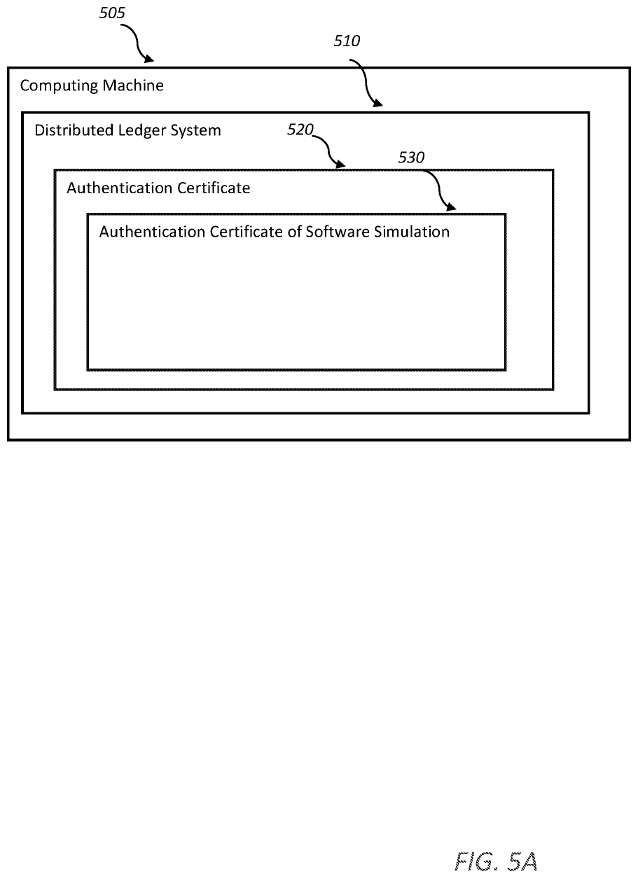

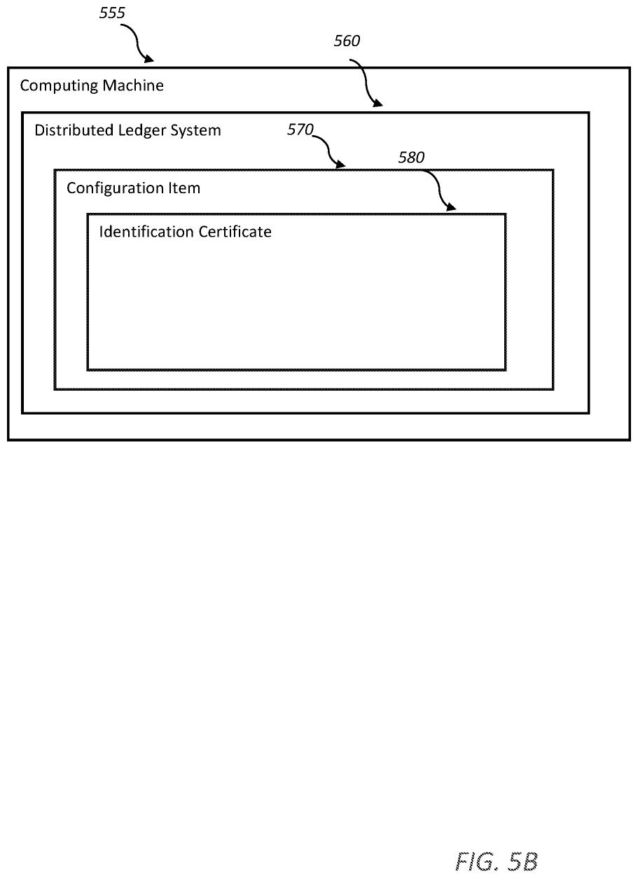

FIG. 5A shows a system in which the authentication certificate for access of an AI software module 520 is recorded into a DLT-enable audit record 510, in turn stored on a computing machine 505. The authentication certificate 520 may be of a software simulation of AI software module or AI or AGI behavior 530, which, in lieu of a formal proof that a given AGI system is safe AGI, may be critical to humanity's survival. All of the foregoing are implemented in a computing machine 505.

Similarly, FIG. 5B shows a system in which the identification certificate for access of an AI software module 580 is incorporated into a DLT-enabled CI 570, in turn stored via DLT 560 on a computing machine 555.

Storage of Utility Function in DLT to Enable BCS

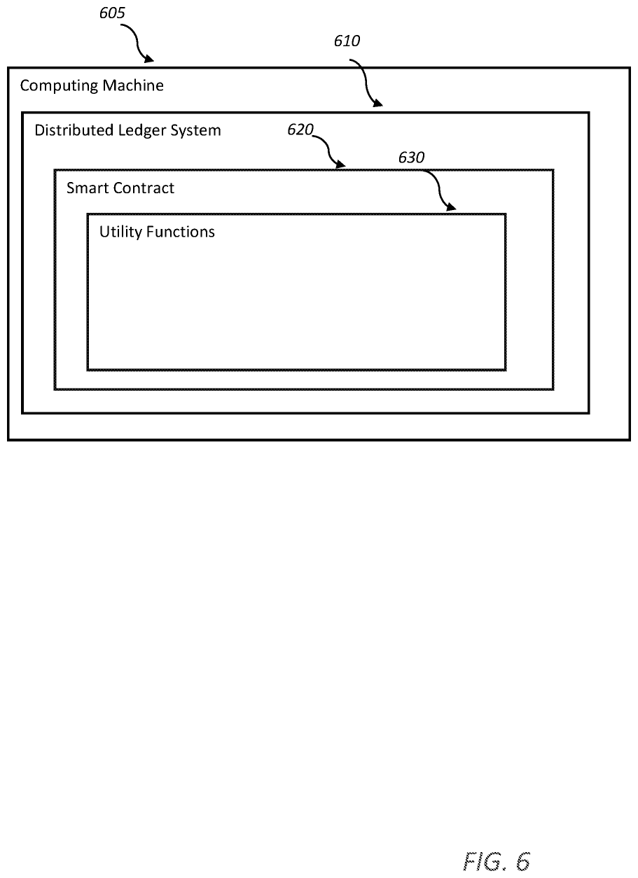

An alternative and more expressive BCS embodiment than presented above may be in the form of a modifiable set of utility functions, which determine AGI actions vis a vis transactions presented to an AGI. FIG. 6 shows such a system in which the utility functions 630 are modifiable only via smart contracts 620 implemented via a secure, non-hackable DLT 610, which in turn is implemented on a computing system 605.

Storage of Social Contract in DLT to Deny Resource Access to AGI

An alternative and more expressive BCS embodiment than presented above may be in the form of a modifiable set of utility functions, which determine AGI actions vis a vis transactions presented to an AGI. FIG. 6 shows such a system in which the utility functions 630 are modifiable only via smart contracts 620 implemented via a secure, non-hackable DLT 610, which in turn is implemented on a computing system 605.

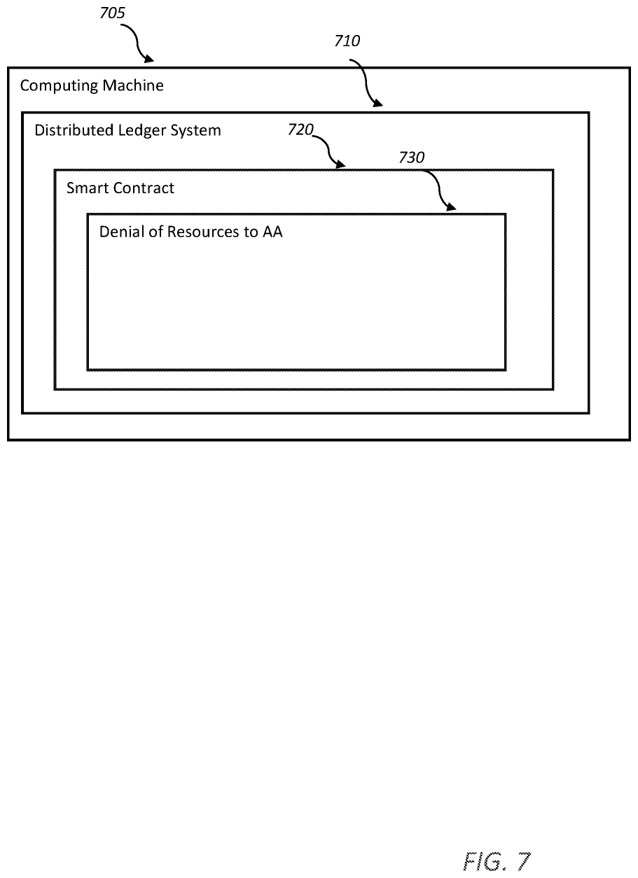

While not provably necessary for safe AGI, the ability to implement the ‘market vote’ aka social ostracism of resources from one or more AAs to AAs is shown in FIG. 7 in which the denial of resources 730 reside on a smart contracts 720 implemented via a secure, non-hackable DLT 710, which in turn is implemented on a computing system 705.

I claim:

1. A system implemented in one or a plurality of computing machines of enforcing contractual access by a human or nonhuman autonomous agent to one or a plurality of autonomous artificial intelligent agents, said method comprised of:
permitting said access via smart contracts,
said contracts stored via distributed ledger technology,
thereby providing a means of rendering said contracts secure from alteration by human or artificial intelligence.

2. A system implemented in one or a plurality of computing machines of securely controlling access to artificial intelligence software modules, said method comprised of:
permitting said access via smart contracts,
said contracts embedded in distributed ledger technology,
thereby providing a mean of rendering said certificate secure from alteration by human or artificial intelligence.

3. A process implemented in one or a plurality of computing machines creating a secure audit trail of artificial intelligence software module usage and performance, said method comprised of:
recording in said audit trail an identification number of an entity accessing said module,
recording in said audit trail an identification number of a smart contract via which said entity accessed said module,
recording in said audit trail errors in said audit trail of actual versus predicted performance of said module,
recording in said audit trail attempts at unauthorized access of said module, and
storing said audit trail via distributed ledger technology,
thereby providing a means of rendering said audit trail secure from alteration by human or artificial intelligence.

4. A system implemented in one or a plurality of computing machines of creating a secure authentication certificate of performance of an artificial intelligent agent, said system comprised of storing said certificate via distributed ledger technology, thereby providing a means of rendering said certificate secure from alteration by human or artificial intelligence.

5. The system of claim 4, in which said certificate authenticates computer simulations of said behavior of said artificial intelligent agent.

6. A system, implemented in one or a plurality of computing machines, of securely embodying utility functions of an autonomous agent in a behavior control system, comprised of the following steps:
storing said utility function in a distributed ledger, and
requiring a smart contract to alter said utility function,
thereby providing a means of rendering said utility functions secure from alteration by human or artificial intelligence.

7. The system of claim 6, further comprising a system of storing contracts via distributed ledger technology, said contracts being between a plurality of autonomous agents, said contracts limiting transfers of property controlled by said agents to a second one or plurality of specified autonomous agents.

8. The system of claim 6, which further comprises a system of ethics in which voluntary transactions are permitted and attempts to force transactions by coercion or induce transactions through fraud are proscribed.
